(19) United States
(12) Patent Application Publication
(10) Pub. No.: US 2004/0231620 A1
(43) Pub. Date: Nov. 25, 2004

(54) Engine with drive ring

(76) Inventor: Antonio Cannata, London (CA)

Correspondence Address: KIRBY EADES GALE BAKER, BOX 3432, STATION D, OTTAWA, ON, K1P 6N9, CA

(21) Appl. No.: 10/443,888

(22) Filed: May 23, 2003

(51) Int. Cl. F02B 75/18

(52) U.S. Cl. 123/56.1

(57) ABSTRACT

A reciprocating engine comprising a cylinder assembly having a pair of connected pistons for reciprocation therein, a drive ring having a rotational orbit substantially encircling the cylinder assembly and a power transfer mechanism for coupling and converting reciprocating motion of the piston to rotating motion of the drive ring. The engine with drive ring can be more compact than an equivalent conventional engine with crankshaft, can generate higher torque and can be subject to less cylinder wall wear due to side thrust of the pistons.

### FIELD OF INVENTION

The present invention relates to the field of reciprocating engines. In particular, to a reciprocating engine having a drive ring.

### BACKGROUND

Reciprocating engines have been known and in common use for more than a century. The basic architecture of the most commonly used of these engines comprises reciprocating pistons connected to a crankshaft via crank throws. As more demanding applications for reciprocating engines are developed the limitations of this commonly used engine architecture are being pushed. The requirements such as those in aerospace and submarine applications for compact, high torque and durable engines are difficult to meet with the classic reciprocating piston and crankshaft architecture. In particular, the use of a crankshaft and its associated geometry contribute to increased engine size, less than optimal torque generation and premature cylinder wall wear due to side thrust loads on the pistons. What is needed is a reciprocating engine that is compact, generates high torque and that mitigates cylinder wall wear.

### SUMMARY OF INVENTION

An embodiment of the reciprocating engine of the present invention comprises a cylinder assembly having a pair of connected pistons for reciprocation therein, a drive ring having a rotational orbit substantially encircling the cylinder assembly and a power transfer mechanism for converting reciprocating motion of the piston to rotating motion of the drive ring. The engine with drive ring can be more compact than an equivalent conventional engine with crankshaft, can generate higher torque and can be subject to less cylinder wall wear due to side thrust of the pistons. The engine with drive ring eliminates the need for a crankshaft with it attendant crank throws and journals.

In accordance with one aspect of the present invention, an engine comprising a cylinder assembly, a pair of connected pistons for reciprocating motion within the cylinder assembly, a drive ring arranged for rotational motion encircling the cylinder assembly; and a power transfer mechanism for converting reciprocating motion of the pair of pistons to rotational motion of the drive ring.

In accordance with another aspect of the present invention, an engine as described in the aspect above wherein the power transfer mechanism comprises: a reciprocating member connected to the pair of pistons, a drive cam connected to the drive ring, and a plurality of cam follower mechanisms connected to the reciprocating member for cooperative engagement with the drive cam.

Other aspects and features of the present invention will become apparent to those ordinarily skilled in the art upon review of the following description of specific embodiments of the invention in conjunction with the accompanying figures.

### BRIEF DESCRIPTION OF DRAWINGS

The present invention will be described in conjunction with the drawings in which:

FIG. 1 is a perspective view of an exemplary embodiment of the engine of the present invention.

FIG. 2 is a side view of an exemplary embodiment of the engine of the present invention.

FIG. 3 is a cross-sectional view of a sub-assembly of an exemplary embodiment of the engine of the present invention.

FIG. 4 is a perspective view of an exemplary embodiment of the engine of the present invention with details of a valve drive mechanism.

FIG. 5 is a perspective view of an exemplary embodiment of the engine of the present invention with details of an alternative valve drive mechanism.

FIG. 6 is a cross-sectional view of an exemplary embodiment of the engine of the present invention with details of an alternative valve drive mechanism.

### DETAILED DESCRIPTION

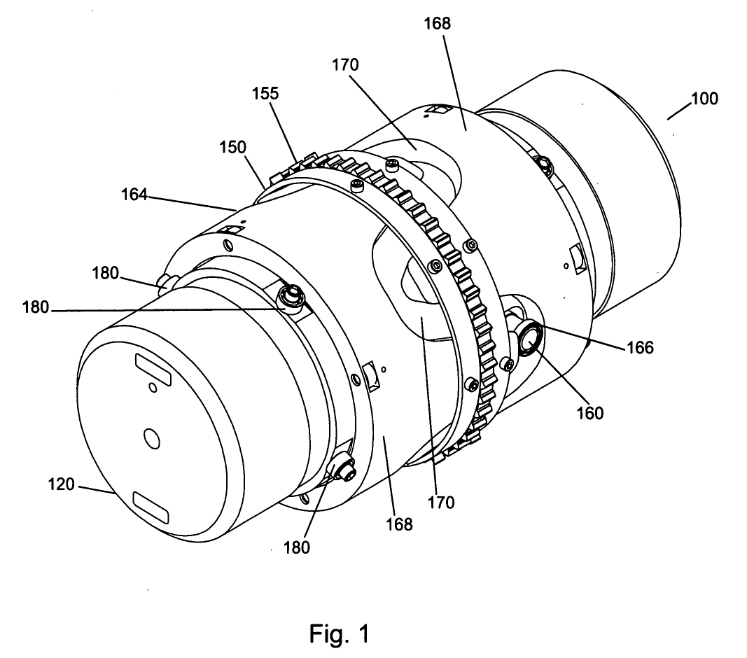

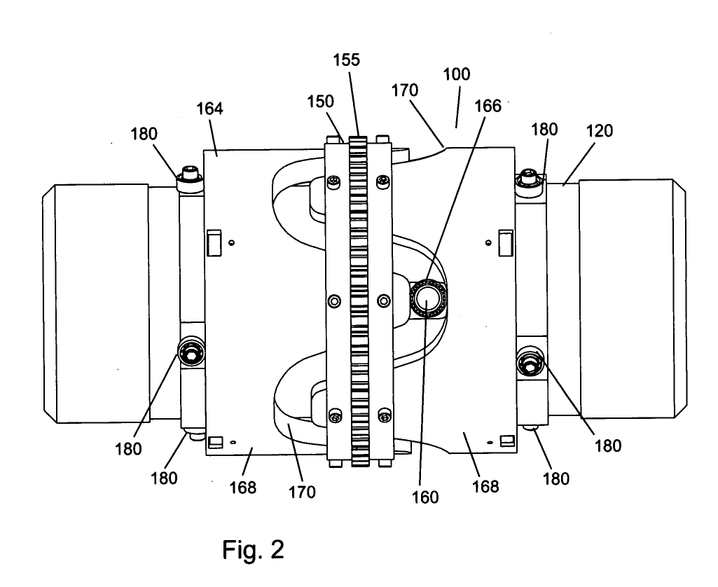

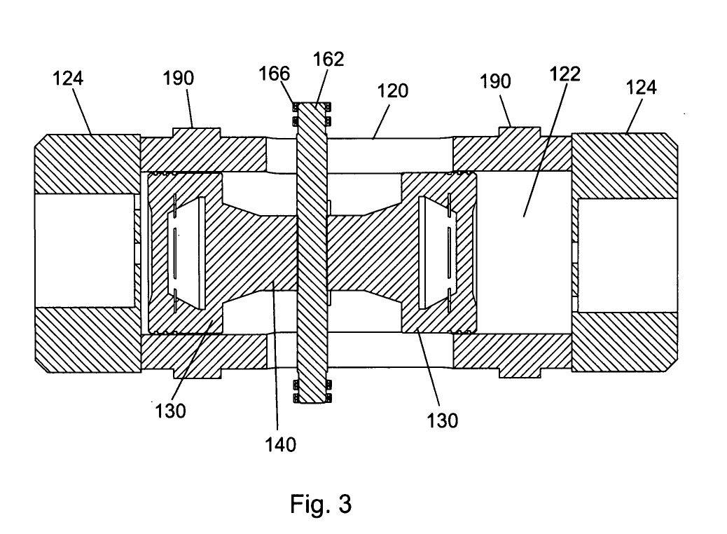

An embodiment of an engine 100 according to the present invention is represented in FIGS. 1-3 (N.B. FIG. 3 represents a sub-assembly of the engine 100). The engine 100 is a reciprocating engine comprising a cylinder assembly 120 having a pair of pistons 130 joined by a connecting rod 140 for reciprocation therein, a drive ring 150 having a rotational orbit substantially encircling the cylinder assembly 120 and a power transfer mechanism 160 for coupling and converting reciprocating motion of the pistons 130 to rotating motion of the drive ring 150. The cylinder assembly 120 comprises a cylinder bore 122 and a pair of cylinder heads 124. Each piston 130 in conjunction with the cylinder bore 122 and one of the cylinder heads 124 defines a combustion chamber. The engine 100 is an internal combustion engine of any of the power cycle types such as, for example, Otto cycle or Diesel cycle and of either two-stroke or four-stroke operation. In an alternative embodiment the engine 100 can be an external combustion engine such as for example a Watt (steam) engine or a Stirling cycle engine.

In normal operation of the engine 100 the pair of pistons 130 and the connecting rod 140 reciprocate, in unison, within the cylinder assembly 120. The power transfer mechanism 160 comprises a reciprocating member 162 that is connected to the pair of pistons 130 via the connecting rod 140, a drive cam 164 connected to the drive ring 150 and a plurality of cam follower mechanisms 166. Reciprocation of the pistons 130 and connecting rod 140 result in reciprocation of the reciprocating member 162. The reciprocating motion of the reciprocating member 162 imparts rotational motion to the drive ring 150 by the coupling of the reciprocating member 162 to the drive cam 164 via the cam follower mechanisms 166.

The reciprocating member 162 in the exemplary embodiment is an elongate member connected, via the connecting rod 140, to the pair of pistons 130 and to one of the plurality of cam follower mechanisms 166 at each of its two ends. In alternative embodiments of the engine 100 the reciprocating member 162 can be one of: an elongate member with one end connected to the pair of pistons 130 and the other end connected to a cam follower mechanism 166, a member connected to the pair of pistons 130 and having more than two ends each one connected to one of the plurality of cam follower mechanisms 166, or other similar structures.

The drive cam 164 in the exemplary embodiment comprises a sinuous recess or grove formed between a pair of cam sections 168 connected to the drive ring 150. Each of the cam sections 168 has a working face 170. The recess is defined by the spatial relationship between the working faces 170 of the pair of cam sections 168. Undulations in the sinuous recess are engineered to provide specific engine characteristics (e.g. torque multiplication) using techniques similar to those used in the design of cam-drive or swash-plate engines. In an alternative embodiment of the engine 100, the drive cam 164 can be formed as part of the drive ring 150, as a separate part or an assembly connected to the drive ring 150 or by an assembly of parts that comprise the drive ring 150. In the exemplary embodiment the cam follower mechanisms 166 are received in the recess of the drive cam 164 between the two working faces 170. In another alternative embodiment the drive cam 164 can comprise a sinuous ridge or protrusion, with two working faces 170, connected to the drive ring 150. In this alternative embodiment substantially opposed cam follower mechanisms 166 cooperatively engage the two working faces 170. In a further alternative of the engine 100, the drive cam 164 can be formed on either or both of the end faces of the drive ring 150.

The cam follower mechanisms 166 of the exemplary embodiment comprises a pair of roller bearings, radially spaced apart relative to the cylinder assembly 120, that cooperate with the working faces 170 of the drive cam 164. The pair of roller bearings comprises an inner bearing and an outer bearing. The inner bearing is proximate the cylinder assembly 120 relative to the outer bearing. The pair of cam sections 168 is arranged such that the inner bearing engages the working face 170 of one of the pair of cam sections 168 and the outer bearing engages the working face 170 of the other of the pair of cam sections 168. Such an arrangement, in which each roller bearing engages only one working face 170, results, during normal engine operation, in each roller bearing rotating only in one direction and prevents binding when the drive ring 150, and therefore the drive cam 164, rotates relative to the reciprocating member 162. In an alternative embodiment of the engine 100, the cam follower mechanisms can comprise, for example, ball bearings, conical bearings or other similar mechanisms.

The drive ring 150 is secured laterally by a plurality of ring retention mechanisms 180. A number of ring retention mechanisms 180, each connected to the cylinder assembly 120, engage the end faces of each of the pair of cam sections 168 that are connected to the drive ring 150. Each of the ring retention mechanisms comprises a roller bearing thereby permitting the drive ring 150 to freely rotate while preventing lateral movement of the drive ring 150. In an alternative embodiment of the engine 100, the ring retention mechanisms 180 can engage the end faces of the drive ring 150 directly. In another alternative embodiment of the engine 100 each of the ring retention mechanisms 180 can comprise a ball bearing, a conical bearings or other similar mechanisms.

A pair of ring carrier mechanisms 190 provide for the free rotation of the drive ring 150 in an orbit that substantially encircles that cylinder assembly 120. In the exemplary embodiment each of the ring carrier mechanisms 190 supports one of the pair of cam sections 168 and thereby the drive ring 150. The ring carrier mechanisms 190 comprise a plurality of roller bearings that permit the free rotation of the drive ring 150. In an alternative embodiment of the engine 100 the ring carrier mechanisms 190 can support the drive ring 150 directly. In another alternative embodiment of the engine 100 each of the ring carrier mechanisms 190 can comprise a ball bearing, a conical bearings or other similar mechanisms. In yet another embodiment of the engine 100 the functions of a ring retention mechanisms 180 and be combined with the functions of a ring carrier mechanisms 190 in a single mechanism.

The drive ring 150 comprises a circumferentially geared face forming a drive gear 155. Power generated by the engine 100 can be imparted to an external driven element having a driven gear (not shown) engaging the drive gear 155. Alternative configurations (e.g. straight cut or beveled) of the drive gear 155 and the driven gear provide for adapting to a driven shaft that is parallel to the axis of rotation of the drive ring 150, that is perpendicular to the axis of rotation of the drive ring 150 or that is at substantially any angle in between the two previously recited orientations. In another alternative embodiment of the engine 100 the drive gear 155 and the driven gear can be connected via a drive chain. In yet another alternative embodiment of the engine 100 the drive gear 155 and driven gear can be replaced by a corresponding drive pulley and a driven pulley connected via a drive belt or other similar power transfer mechanisms.

In an alternative embodiment of the engine 100 the cylinder assembly 120 and connecting rod 140 can be adapted to operation with a single piston 130. In a further alternative embodiment, the engine 100 comprises a plurality of cylinder assemblies 120 arranged to be substantially encircled by the rotational orbit of the drive ring 150 with the pistons 130 of each of the plurality of cylinder assemblies 120 connected to the drive ring 150 via a power transfer mechanism 160.

In the exemplary embodiment of the engine 100 represented in FIGS. 1-3 the axis of rotation of the drive ring 150 is substantially parallel to the longitudinal axis of the cylinder assembly 120. In an alternative embodiment of the engine 100 the axis of rotation of the drive ring 150 can be at a non-zero angle to the longitudinal axis of the cylinder assembly 120 and the power transfer mechanism 160 can be adapted appropriately.

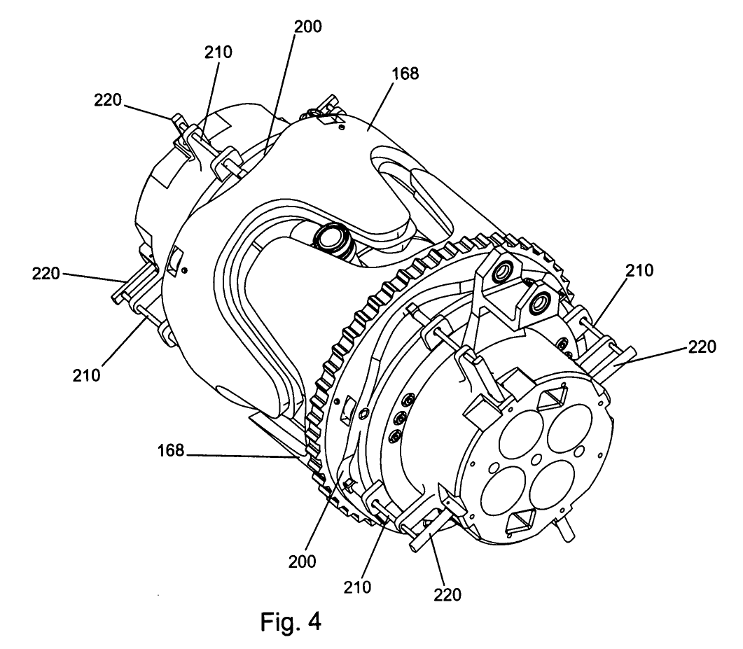

Referring now to FIG. 4 which represents an exemplary embodiment of the engine 100 of the present invention with detailed features of a valve (induction and exhaust) drive mechanism comprising a pair of sinuous valve timing cams 200, a plurality of push rods 210 and a plurality of rocker arms 220. One of the pair of sinuous valve timing cams 200 is formed on each of the cam sections 168 which are coupled to the drive ring 150. Each of the plurality of push rods 210 engage, at one end, one of the valve timing cams 200. Each of the plurality of push rods 210, at its other end, engages one of the plurality of rocker arms 220 that provide for valve actuation. Although the exemplary embodiment illustrates a single valve timing cam 200 per cam section 168, it will be understood that multiple valve timing cams 200 can be provided for each cam section 168. Multiple valve timing cams 200 can provide, for example, different timing of induction and exhaust valves or different timing between multiple induction or multiple exhaust valves.

In a further alternative embodiment of the engine 100 one or more of the valve timing cams 200 can be formed directly on the drive ring 150.

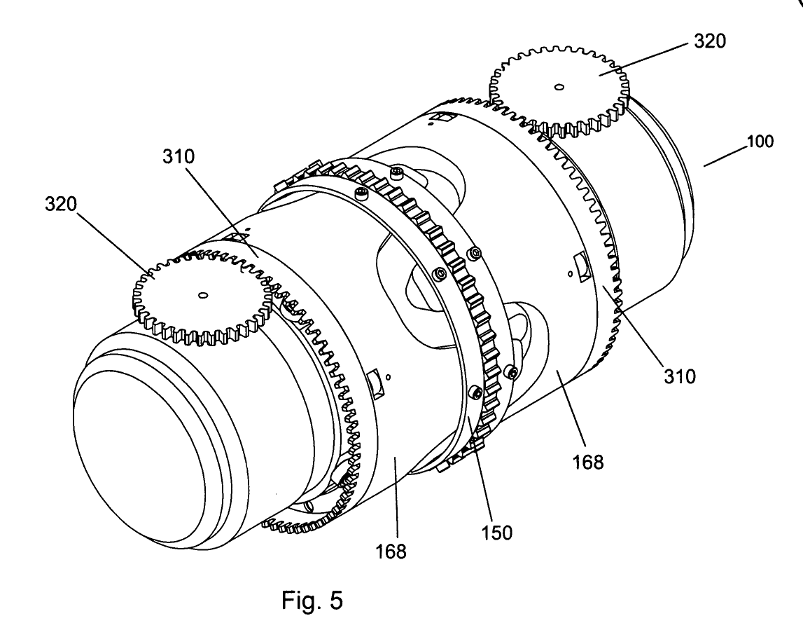

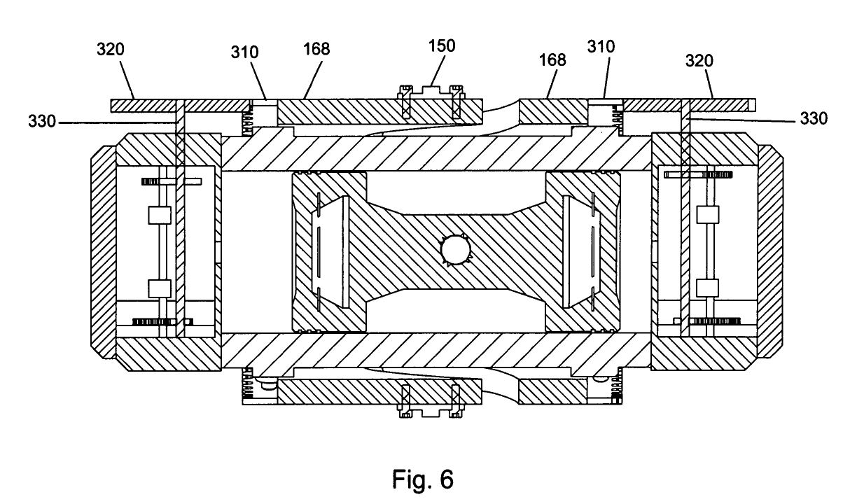

FIGS. 5 and 6 represent another exemplary embodiment of the engine 100 of the present invention with detailed features of an alternative valve drive mechanism comprising a pair of cam ring gears 310, a pair of cam gears 320 and a pair of cam drive shafts 330. One of the pair of cam ring gears 310 is connected to each of the cam sections 168 that are coupled to the drive ring 150. Each one of the pair of cam gears 320 engages one of the pair cam ring gears 310. Each one of the cam drive shafts 330 is connected to one of the pair of cam gears 320. The cam drive shafts 330 provide for valve actuation through additional well-known mechanisms such as cam shafts, rocker arms and other similar mechanisms. Although the exemplary embodiment illustrates a single cam ring gear 310 per cam section 168, it will be understood that multiple cam ring gears 310 can be provided for each cam section 168. Multiple cam ring gears 310 can provide, for example, different timing of induction and exhaust valves or different timing between multiple induction or multiple exhaust valves. In a further alternative embodiment of the engine 100 one or more of the cam ring gears 310 can be coupled directly to the drive ring 150.

It will be understood by those skilled in the art that a reciprocating pump with a drive ring having a structure similar to that of any of the embodiments the engine of the present invention described above falls within the scope and spirit of the present invention. In the case of a reciprocating pump having a drive ring, power is received by the pump via the rotation of the drive ring and is converted and transferred to reciprocating motion of the pistons.

It will be apparent to those skilled in the art that numerous modifications and departures from the specific embodiments described herein may be made without departing from the spirit and scope of the present invention.

1. An engine comprising:
a cylinder assembly;
a pair of connected pistons for reciprocating motion within said cylinder assembly;
a drive ring arranged for rotational motion encircling said cylinder assembly; and
a power transfer mechanism for converting reciprocating motion of said pair of pistons to rotational motion of said drive ring.

2. The engine of claim 1, said power transfer mechanism comprising:
a reciprocating member connected to said pair of pistons;
a drive cam connected to said drive ring; and
a plurality of cam follower mechanisms connected to said reciprocating member for cooperative engagement with said drive cam.

3. The engine of claim 2, wherein said reciprocating member is an elongate member connected to said pair of pistons and to one of said plurality of cam follower mechanisms at each of two ends.

4. The engine of claim 3, said drive cam comprising:
a pair of cam sections each with a working face; and
a sinuous recess formed between the working faces of said pair of cam sections.

5. The engine of claim 4, each of said plurality of cam followers comprising:
an outer bearing; and
an inner bearing proximate the cylinder assembly relative to said outer bearing;
wherein each of said outer bearing and said inner bearing cooperatively engages said
working face of one of said pair of cam sections.

6. The engine of claim 1, said drive ring comprising a drive gear for imparting power generated by said engine to an external driven element.

7. The engine of claim 6, said drive gear comprising a circumferentially geared face.

8. The engine of claim 4, further comprising a valve drive mechanism having:
a sinuous valve timing cam coupled to said drive ring;
a plurality of rocker arms for valve actuation; and
a plurality of push rods each engaging, at one end, one of said sinuous timing cams and, at the other end, one of said plurality of rocker arms.

9. The engine of claim 4, further comprising a valve drive mechanism having:
a cam ring gear coupled to said drive ring;
a plurality of cam drive shafts for valve actuation; and
a plurality of cam gears each engaging one of said cam ring gears and connected to one of said plurality of cam drive shafts.

10. An engine comprising:
a cylinder assembly;
a piston for reciprocating motion within said cylinder assembly;
a drive ring for rotational motion encircling said cylinder assembly; and
a power transfer mechanism for converting reciprocal motion of said piston to rotational motion of said drive ring.

11. The engine of claim 10, said power transfer mechanism comprising:
a reciprocating member connected to said piston;
a drive cam connected to said drive ring; and
a plurality of cam follower mechanisms connected to said reciprocating member for cooperative engagement with said drive cam.

12. An engine comprising:
a plurality of cylinder assemblies each having a pair of connected pistons for reciprocating motion therein;
a drive ring arranged for rotational motion encircling said plurality of cylinder assemblies; and
a power transfer mechanism for converting reciprocal motion of each said pair of pistons to rotational motion of said drive ring.

13. The engine of claim 12, said power transfer mechanism comprising:
a reciprocating member connected to each said pair of pistons;
a drive cam connected to said drive ring; and
a plurality of cam follower mechanisms connected to said reciprocating member for cooperative engagement with said drive cam.
